(19) United States
(12) Patent Application Publication
(10) Pub. No.: US 2003/0099276 A1
(43) Pub. Date: May 29, 2003

(54) Instrument for measuring the power emitted by a source of coherent or incoherent radiation, particularly of the laser type, and method related thereto

(76) Inventor: Luigi Argenti, Milano (IT)

Correspondence Address: MODIANO & ASSOCIATI, Via Meravigli, 16, Milano, 20123, IT

(21) Appl. No.: 10/295,988

(22) Filed: Nov. 18, 2002

(30) Foreign Application Priority Data
Nov. 23, 2001 (IT) MI2001A002475

(51) Int. Cl. G01J 5/00

(52) U.S. Cl. 374/121

(57) ABSTRACT

An instrument for measuring the power emitted by a source of coherent or incoherent radiation, particularly of the laser type, which comprises an absorbent mass of known heat capacity connected to a supporting body comprising means for sensing the variation over time of the temperature of the absorbent mass struck by a laser radiation whose power is to be measured. The measurement time is significantly shorter than the thermal time constant of the absorbent mass. The sensing means are connected to a central unit for processing the data and calculating the power, which can be displayed on a display.

### BACKGROND OF THE INVENTION

The present invention relates to an instrument for measuring the power emitted by a source of coherent or incoherent radiation, particularly of the laser type.

As is known, the diffusion of laser systems is increasing; in addition to the typical field of telecommunication systems, such laser systems have been applied considerably in solid-state and metal-related technology in general and in the manufacture of motor vehicles, in particular, where the laser is used to cut and shape the metal plates and to weld one another the various components of a same motor vehicle.

Industrial cutting and welding processes that use laser systems, thanks to their considerable efficiency, are fully automated.

It should be noted that the efficiency, validity and reproducibility of the results are strictly linked to control and stability of the process parameters, among which the power delivered by the laser is particularly important.

Currently, two different types of calorimeter are commonly used to monitor the power of the radiation emitted by the laser.

A first calorimeter measures, by means of a thermopile, the radial temperature gradient generated by the flow of heat produced by the radiation absorbed on a metallic disk; the signal of the thermopile is directly proportional to the power of the radiation emitted by the laser.

This type of calorimeter allows to perform continuous power measurement, with a time resolution of a few seconds and with good precision, which can be estimated to be on the order of 2%.

This type of calorimeter has a high cost, and furthermore its use requires accurate and stable alignment of the laser beam and its operation requires an efficient water-type cooling circuit; therefore, this type of calorimeter is seldom used in the industrial field owing to long machine downtimes and excessive setup times.

A second type of instrument is the so-called ballistic calorimeter, which is constituted by an absorbent mass of known heat capacity and by a bimetallic thermometer that is monolithic with the absorbent mass and detects the temperature increase.

The power is measured by exposing the mass to laser radiation for a clearly defined time interval, for example 20 seconds, and the temperature reached by the mass is recorded by the thermometer, by means of a particular quadrant scale calibrated in watts.

This type of instrument allows to estimate the average value of the power of the laser over a 20-second interval and is undoubtedly inexpensive, simple and easy to use, but has a limited dynamic range and mediocre precision.

Furthermore, for its correct use, it is essential to measure the exposure time with a precision of at least 0.2 seconds, and before performing a subsequent measurement it is necessary to cool with water the absorbent mass of the calorimeter.

### SUMMARY OF THE INVENTION

The aim of the present invention is to eliminate the drawbacks noted above by providing an instrument for measuring the power emitted by a source of coherent or incoherent radiation, particularly of the laser type, that is capable of combining precision, low cost and simplicity with the possibility of quick and easy readout.

Within this aim, an object of the invention is to provide an instrument that does not require precise control of alignment with respect to the laser source and also does not force the user to perform precision control of the exposure time.

Another object of the present invention is to provide a fully electronic instrument that is also capable of providing the deviation or uncertainty of the measurement made.

Another object of the present invention is to provide an instrument that thanks to its particular constructive characteristics is capable of giving the greatest assurances of reliability and safety in use and is further competitive from a merely economical standpoint.

This aim and these and other objects that will become better apparent hereinafter are achieved by an instrument for measuring the power emitted by a source of coherent or incoherent radiation, particularly of the laser type, which comprises an absorbent mass of known heat capacity connected to a supporting body, characterized in that it comprises means for sensing the variation over time of the temperature of said absorbent mass struck by a laser radiation whose power is to be measured, said sensing means being connected to a central unit for processing the data and calculating the power, which can be displayed on a display.

### BRIEF DESCRIPTION OF THE DRAWINGS

Further characteristics and advantages of the present invention will become better apparent from the description of a preferred but not exclusive embodiment of an instrument for measuring the power emitted by a source of coherent or incoherent radiation, particularly of the laser type, illustrated by way of non-limitative example in the accompanying drawings, wherein:

FIG. 1 is a schematic perspective view of the instrument according to the invention;

FIG. 2 is a detail view of the display;

FIG. 3 is a schematic view of the temperature measurement chart.

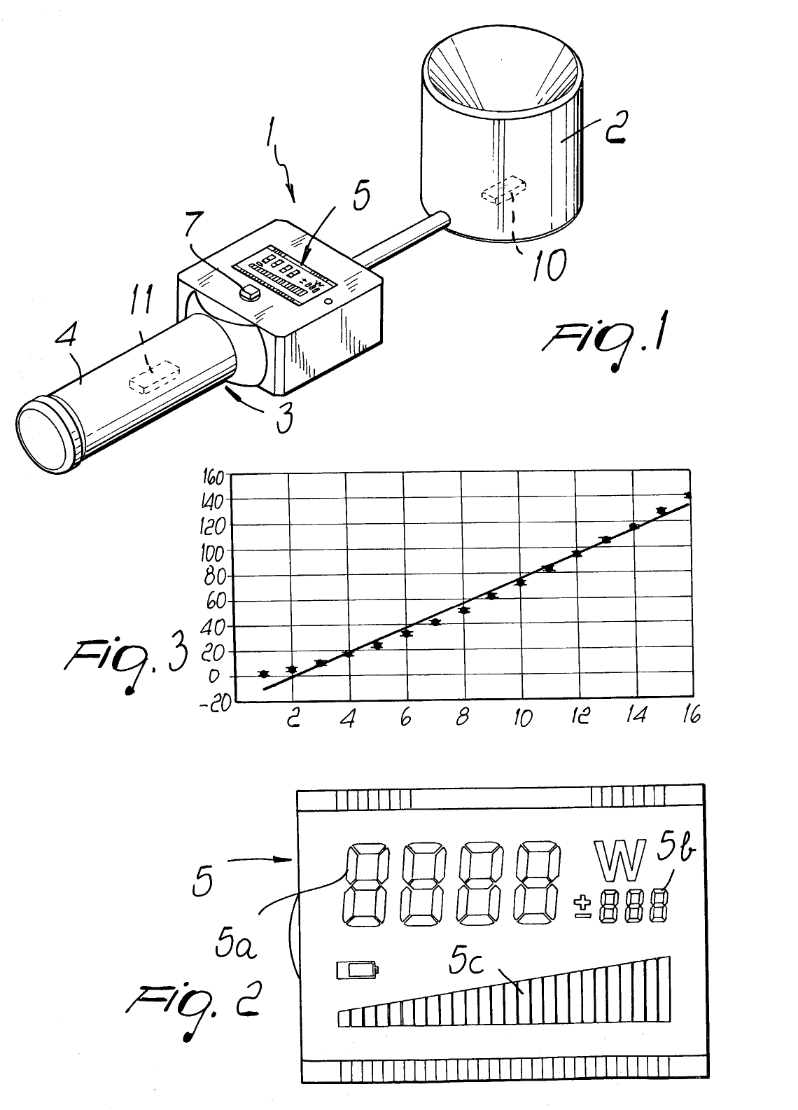

### DESCRIPTION OF THE PREFERRED EMBODIMENTS

With reference to the figures, the instrument for measuring the power emitted by a source of coherent or incoherent radiation, particularly of the laser type, according to the invention, generally designated by the reference numeral 1, comprises an absorbent mass 2 having a known heat capacity, which is connected to a supporting body 3, which has a handle portion 4 and a display 5.

The instrument 1 comprises means for sensing the variation over time of the temperature; said means are advantageously provided by a first temperature sensor 10 and a second temperature sensor 11, which are constituted for example by a first thermocouple 10 or by a thermopile that is placed in close thermal contact with the center of gravity of the absorbent mass 2 and by a second thermocouple 11 or by a thermopile that is arranged inside the supporting body, for example inside the handle 4.

It is also possible to arrange the first and second sensors on the thermal mass in two spaced points, for example one sensor in a central region of the absorbent mass and the other sensor in a radially spaced point.

Such thermal sensor is designed to sense the variation over time of the temperature of the absorbent mass; i.e., the temperature increase over a very limited time is sensed, as explained hereinafter.

The two thermocouples 10 and 11, which are advantageously of the copper-constantan type and constantan-copper type, are connected in series to each other, are thermally insulated from each other, and are joined by two conductors with a diameter that ensures a response time of less than one second.

The thermoelectric pile produced by the two thermocouples provides, in practice, an electromotive force that is linear for ΔT, i.e., temperature variations of less than 150-200° K.

Furthermore, the absorbent mass 2 is sized so as to obtain thermal differences of approximately 100° K, which in practice correspond to 4.2 mV.

The means for sensing the variation of the temperature over time are functionally connected to a microprocessor, which manages both the acquisition and power calculation algorithm and the liquid-crystal display 5, which has a first region 5a for the power value, expressed in watts, and a second region 5b for measurement uncertainty.

Furthermore, on the display 5 there is a bar chart, designated by the reference numeral 5c, which displays the temperature level reached by the absorbent mass during measurement.

A button 7 for operating and resetting the instrument is also provided.

In practical use, in order to determine the value of the power of a laser source it is sufficient to place the absorbent mass in the laser beam and wait for the acoustic signal of a piezoelectric buzzer and/or for the lighting of an LED, which indicates that the measurement has occurred and that the instrument can be removed from the laser beam.

In practice, upon exposure to the laser beam, the temperature of the absorbent mass 2 increases, and once it has reached a preset threshold, found experimentally to be 1° K, measurement begins, approximately 2 seconds after starting, which is the thermalization time of the mass, after which the temperature rises in a linear fashion as shown schematically in FIG. 3, which plots on the abscissas the times in seconds and on the ordinates the temperature variation in °K. Actual data acquisition starts after the thermalization period; during acquisition, the measurement samples are acquired for a time comprised between 2 and 10 seconds, preferably 5 seconds; said samples can be 50-100, and the incremental ratio of the temperature variation over time is calculated on these samples by way of a linear regression that is mathematically more indicative than an average and than the incremental ratio. This calculation system allows to obtain resolutions higher than 1 part in one thousand.

In practice, if x is the time expressed in seconds, y is the temperature variation measured in K and n is the number of samples on which the coefficients are calculated, one obtains a variation coefficient m that is represented by the following formula:

$$m = \frac{n Σ x y - Σ x Σ y}{n Σ {x}^{2} - {( Σ x )}^{2}} ° \text{K/s}$$

Moreover, it is possible to calculate a correlation coefficient r that allows to represent the uncertainty of the measurement. This coefficient can be obtained from the following formula:

$$r = \frac{n Σ x y - Σ x Σ y}{sqrt ( ( n Σ {x}^{2} - {( Σ x )}^{2} ) ( n Σ {y}^{2} - {( Σ y )}^{2} ) )} 0 < r \leq 1$$

Once the measurement has been performed, the display displays the power of the laser beam, which in practice is m.C, where C is the thermal constant of the mass used.

At the end of data acquisition, a green LED lights up for approximately 2 seconds to indicate that the measurement has ended, and the value of the measured power is displayed on the display; advantageously, this value is stored and maintained, even when the instrument is switched off, until a subsequent reset is performed.

In addition to the last measured power level, the instrument might also store and display the uncertainty of the measurement.

It should be noted that the acquisition time was mentioned earlier as 5 seconds, but it is obviously also possible to use other and possibly shorter times, and it is also possible to preset the instrument for storing various masses and amplifications of the signal of the thermoelectric pile and to vary the sampling rate, the ΔT for measurement start and the wait times for thermalization; it is also possible to insert characteristic curves of the heating of the absorbent mass if said heating is not linear. The scale 5c is further provided on the display and allows to avoid the overheating of the absorbent mass; if such overheating occurs during a measurement, it will produce an error indication on the display; if it occurs at the end of the measurement, it provides the measurement and displays a signal to indicate the need to cool the instrument.

As regards the uncertainty or deviation of the measurement, it can be estimated experimentally as the square root of 1-r², calculated in the manner mentioned earlier.

It is thus evident from the above description that the present invention achieves the intended aim and objects, and in particular the fact is stressed that starting from the concept of using the variation over time of the temperature value of the absorbent mass it is possible to have an indication, in extremely short times, of the power of the laser source without constraints arising from the correct alignment on the laser beam of the sensing element and without being subject to critical sensing times.

In the specific case, sensing of the thermal variation allows, over time intervals that can be estimated to be on the order of a few seconds, to have a “curve” that in practice can be correlated to the power value, together with the possibility to indicate any uncertainly or deviation in measurement that can be obtained in real time.

It should also be added that the instrument according to the invention can be used in all fields in which it is necessary to measure the power emitted by devices in general, such as for example plasma torches, burners, cutting and welding torches, blowers, Bunsen burners, kitchen burners and incoherent radiating sources in general.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2001A002475 from which this application claims priority are incorporated herein by reference.

What is claimed is:

1. An instrument for measuring the power emitted by a source of coherent or incoherent radiation, comprising an absorbent mass of known heat capacity connected to a supporting body, wherein it comprises means for sensing the variation over time of the temperature of said absorbent mass struck by a laser radiation whose power is to be measured, said sensing means being connected to a central unit for processing the data and calculating the power, which can be displayed on a display.

2. The instrument according to claim 1, wherein said means for sensing the temperature variation over time comprise a first temperature sensor and a second temperature sensor.

3. The instrument according to claim 2, wherein said first temperature sensor and said second temperature sensor are arranged respectively in close thermal contact in two spaced points of the absorbent mass.

4. The instrument according to claim 2, wherein said first temperature sensor and said second temperature sensor are arranged respectively in close thermal contact with a central portion of the absorbent mass and in at least one point that is spaced radially from said central portion.

5. The instrument according to claim 2, wherein said first temperature sensor and said second temperature sensor are arranged respectively in close thermal contact with the center of gravity of the absorbent mass and inside said supporting body, which is thermally insulated from said absorbent mass.

6. The instrument according to claim 2, wherein said first temperature sensor and said second temperature sensor are constituted by at least one thermocouple.

7. The instrument according to claim 6, wherein said thermocouples are of the copper-constantan and constantan-copper type.

8. The instrument according to claim 2, wherein said first temperature sensor and said second temperature sensor comprise a thermopile.

9. The instrument according to claim 6, comprising two copper conductors for the series connection of said thermocouples with a response time of less than 1 second.

10. The instrument according to claim 1, wherein said central unit for processing the data and calculating the power level comprises a microprocessor that is suitable to manage the acquisition and power calculation algorithm.

11. The instrument according to claim 1, wherein said display comprises liquid crystals for indicating the power level expressed in watts, liquid crystals for displaying the uncertainty of the measurement, and a bar chart for displaying the level of the temperature reached by said absorbent mass.

12. A method for measuring the power emitted by a source of coherent or incoherent radiation, particularly of the laser type, consisting in: acquiring a plurality of data related to the linear temperature variation of an absorbent mass struck by a radiation emitted by a source of coherent or incoherent radiation; calculating, by means of a linear regression, the incremental ratio of the temperature variation over a time interval that is significantly shorter than the thermal time constant of the absorbent mass; calculating the power on the basis of the temperature variation coefficient and on the capacity of said absorbent mass.

13. The method according to claim 12, wherein measurement starts automatically after the initial variation of the temperature by at least 1° K and after a period substantially on the order of 2 seconds for the thermalization of said absorbent mass.

14. The method according to claim 13, wherein the acquisition time of the data related to the temperature increase is between 2 and 10 seconds.
